(19) United States
(12) Patent Application Publication
(10) Pub. No.: US 2004/0132347 A1
(43) Pub. Date: Jul. 8, 2004

(54) Electrical connector provided with removable rotation blockage

(76) Inventors: Jean-Pierre Souvay, Saverne (FR); Manuel Kesseler, Haguenau (FR)

Correspondence Address: YOUNG & THOMPSON, 745 SOUTH 23RD STREET 2ND FLOOR, ARLINGTON, VA, 22202

(21) Appl. No.: 10/704,567

(22) Filed: Nov. 12, 2003

(30) Foreign Application Priority Data
Nov. 12, 2002 (EP) 02360310.3

(51) Int. Cl. H01R 13/64

(52) U.S. Cl. 439/681

(57) ABSTRACT

Electrical connector, male or female, has a tubular body of an insulating material, carrying male or female connection terminals, and a cylindrical sleeve mounted with the possibility of rotation on the external surface of the tubular body. The connector comprises moreover a member in the shape of a ring, also mounted on the external surface of the tubular body with the possibility of translation relative thereto and being secured in rotation therewith. The member is provided with engagement elements and is displaceable slidably into a locking position in which these engagement elements come into engagement with complementary engagement elements of the cylindrical sleeve, so as to render this latter also secured in rotation with the tubular body by the member.

The present invention relates to the field of connectors, in particular connectors or cords, cables or similar connection elements, and has for its object an electrical connector provided with rotation blockage, preferably removable, and a connector cord comprising at least one such connector.

The present invention relates to an electrical connector, male or female, of the type comprising a tubular body of insulating material, carrying male or female connection terminals, and a cylindrical sleeve mounted with the possibility of rotation on the external surface of said tubular body.

Generally, this cylindrical sleeve is blocked in translation on said tubular body.

Nevertheless, for connectors of this type, it is in certain cases necessary to be able also to block the sleeve in rotation, particularly when this latter comprises or contributes to the connection of the connector in question with a suitable connector or a complementary connector and the locking of said connection is connected to a rotation and/or a blockage in rotation of said sleeve.

Such is particularly the case, when said sleeve is part of a bayonet connection, a screw connection, a resilient gripping connection, or else a connection for coaction with complementary shapes, associated with a specific rotational position of said sleeve.

The problem of the present invention consists thus in providing a connector of the mentioned type with a simple and effective means for locking, if desired removably, the cylindrical sleeve in rotation.

To this end, the present invention has for its object a connector of the mentioned type, characterized in that it comprises moreover a member in the shape of a ring, also mounted on the external surface of said tubular body with the possibility of translation relative to this latter and being secured in rotation to this latter, said member being provided with engagement means and being adapted to be moved slidably into a locking position in which these engagement means come into engagement with complementary engagement means of the cylindrical sleeve, so as to render this latter also fixed in rotation with said tubular body by means of said member.

The invention will be better understood from the following description, which relates to preferred embodiments, given by way of non-limiting examples, and explained with reference to the accompanying schematic drawings, in which:

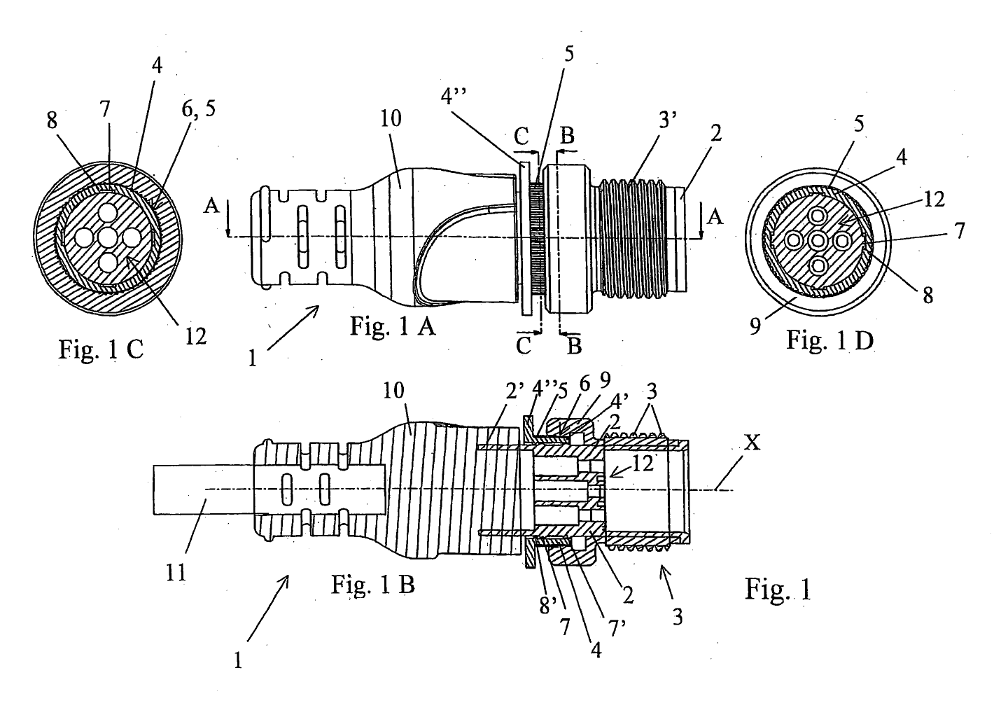

FIG. 1A is a side elevational view of a connector according to a first embodiment of the invention, on which the cylindrical sleeve is not blocked in rotation, and FIGS. 1B, 1C and 1D are respectively cross sectional views on the lines A-A, B-B, and C-C of the connector of FIG. 1A;

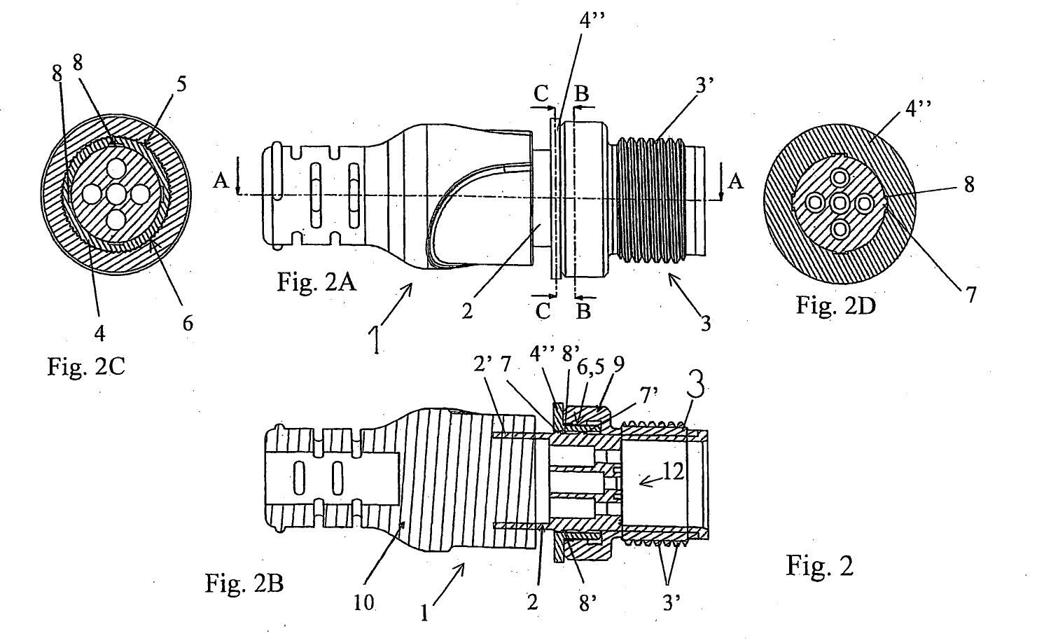

FIG. 2A is a side elevational view of the connector of FIG. 1 on which the cylindrical sleeve is blocked in rotation, and FIGS. 2B, 2C and 2D are respectively cross sectional views on the lines A-A, B-B and C-C of the connector of FIG. 2A;

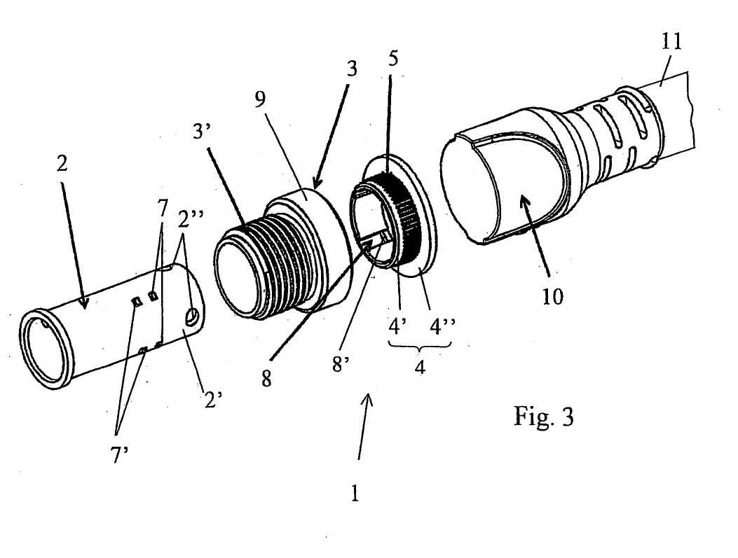

FIG. 3 is an exploded perspective view of the connector shown in FIGS. 1 and 2 and corresponding to a connector with a male mechanical connection interface, and,

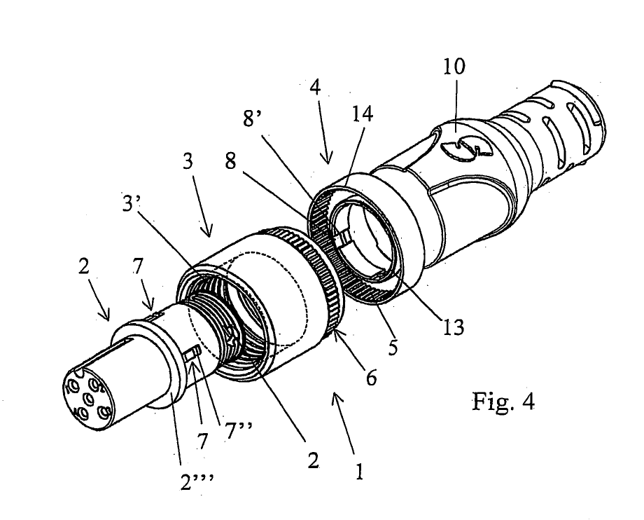

FIG. 4 is an exploded perspective view, similar to that of FIG. 3, of a connector according to a second embodiment of the invention, corresponding to a connector with one end or interface of a female mechanical connection.

As shown in FIGS. 1 to 4 of the accompanying drawings, the electrical connector 1 comprises a tubular body 2 of an insulating material, carrying male or female connection terminals, and a cylindrical sleeve 3 mounted rotatably on the external surface of said tubular body 2.

The tubular body 2 will comprise several reception sites 12 for connection wires and connection terminals.

According to the invention, this connector 1 moreover comprises a member 4 in the form of a ring, also mounted on the external surface of said tubular body 2 with the possibility of translation relative to this latter and being secured in rotation to this latter, said member 4 being provided with engagement means 5 and being adapted to be moved slidably into a locking position in which these engagement means 5 come into engagement with complementary engagement means 6 of the cylindrical sleeve 3, so as to render this latter also fixed in rotation to said tubular body 2 by means of said member 4.

Thus, the blockage in rotation of the sleeve 3 relative to the body 2 is obtained by simple limited translatory movement of the member 4. A movement in the opposite direction of this latter, from its position of locking or blocking in rotation, will accordingly give rise to a freeing in rotation of said sleeve 3 from said body 2.

As shown particularly in FIGS. 1A, 1B, 2A, 2B and 3, the connector 1 has a structure substantially symmetrical about its longitudinal axis X.

According to a first characteristic of the invention, the connection that is blocked in rotation and freed in translation, between the tubular body 2 and the sliding member 4 forming an intermediate ring for locking in rotation, is comprised by at least one coacting assembly lug(s) or rib(s) 7, 7′/groove 8, in which the groove 8 extends in the axial direction of the connector 1 and forms a slideway for said lug or lugs or rib or ribs 7, 7′, said at least one lug or rib 7, 7′ being formed on the wall of one of said tubular body 2 and sliding member 4, and the groove 8 being provided in the wall of another of said tubular body 2 sliding member 4.

The lug or lugs 7, 7′ or the rib 7 will provide a base or bases of sufficiently cross section to provide resistance to the corresponding shear arising from the desired blocking force.

Moreover, the lug or lugs 7, 7′ or the rib 7 are preferably in surface contact with the bottom of the corresponding groove 8, by for example both having a cross section of rectangular shape.

According to a preferred modified embodiment of the invention, said connector 1 comprises at least two, preferably four, coacting assemblies 7, 7′; 8 disposed equiangularly about the axis of said connector 1.

Moreover, each coacting assembly comprises at least two lugs 7 and 7′ axially aligned or one rib 7 with an axial extent, said lugs 7 and 7′ or said rib 7 being formed on the external surface of the tubular body 2, the grooves 8 being formed on or in the internal surface of the sliding member 4 in the form of a ring.

So as to be able to provide easy discrimination between the locked and unlocked positions (that is to say corresponding to securement respectively or loosening, in rotation between the body 2 and the sleeve 3) and to guarantee holding of the locked position by gripping, the or each groove 8 comprises, at the level of its bottom, a protuberance 8′ forming an indexing lug whose passage above a lug 7 or into a cutout or a reinforcement 7″ of the rib 7 of the coacting assembly 7, 7′; 8 in question, during sliding of the slidable member 4 in the shape of a ring toward the locking position or blockage in rotation, corresponds to the establishment of the securement in rotation of the cylindrical sleeve 3 with the tubular body 2, said lug 7 or said cutout 7″ also ensuring the retention of said lug 8′ in the locking position.

This retention could, as a function of the shape, dimensions and/or materials of the protuberance 8′ and of the lug or of the rib 7, be of a permanent nature (non-removable) or temporary (removable), this latter solution being preferred and requiring a construction of said elements 8′ and 7 permitting a bidirectional passage of the lug 8′ over the lug 7 at the level of each coacting assembly (sloped flank and/or rounded edges).

According to a desirable embodiment of the invention, referring also to the accompanying drawings, the engagement means 5 of the sliding member 4 in the shape of a ring consist in radial notches, preferably profiled in the axial direction of the connector 1, formed on the external or internal surface of said member 4 and the complementary engagement means 6 of the cylindrical sleeve 3 consist of a circular rib, also provided or constituted by radial notches or made of a material less hard than that forming the engagement means 5 of the slidable member 4, said rib 6, notched or not, being formed on the external surface of the cylindrical sleeve 3 or in the internal surface of an annular portion 9 of greater diameter of said cylindrical sleeve 3.

As a function of the solution provided, the slots 5 as a result come into engagement by alternate imbrication or engagement with the notches of the rib 6, or thus impress themselves in the material forming the internal or external rib 6 of the annular portion 9, by ensuring in both cases a securement in rotation of the member 4 with the sleeve 3.

So as to be able desirably to ensure the locking or blockage in rotation in no matter what angular position of the sleeve 3, the radial notches 5 are present, in a continuous manner, over all the external or internal periphery of the slidable member 4 in the shape of a ring and a circular rib 6 forming the complementary engagement means is also provided with notches, the coacting assemblies 7, 7′/8 having a radial play permitting limited rotation of the tubular body 2 with the slidable member 4 in the form of a ring (the elements 7, 7′ could for example have a lesser width than the width of the groove 8).

It will thus always be possible to align the two notched engagement means 5 and 6, such that the notches of said two means can mutually inter-engage to provide the blockage in rotation of the sleeve 3 with the member 4.

So as to guarantee or to force this mutual engagement or imbrication at least at the level of certain peripheral locations, a portion of the rib 7 or of the lugs 7′ of each coacting assembly of lugs 7, 7′/groove 8 can be disposed facing the internal or external circular rib 6 of the cylindrical sleeve 3, so as to force the radial notches 5 of the slidable member 4 towards said notched rib 6 or not or vice versa (FIG. 4), and to guarantee the mutual engagement of the engagement means 5 and 6 in the locked position.

According to a first embodiment of the invention, the member 4 can comprise a first tubular portion 4′ carrying on its external surface the engagement means 5 and a second annular portion 4″ that radially protrudes toward the outside and forming a phalange, thereby constituting an abutment shoulder against the cylindrical sleeve 3 in the locked position and a grip for the driving in translation of said member 4 (FIGS. 1 to 3).

According to a second embodiment of the invention, the member 4 in the shape of a ring comprises, formed in a single piece therewith and concentric, a first annular structure 13 carrying on its internal surface the grooves 8 and a second annular structure 14 contiguous to the first structure 13, of greater diameter and carrying on its internal surface the engagement means 5, the tubular body 2 being provided with an external annular abutment 2′″ that comes into contact, after assembly, with the edge of the annular structure 13 or against the shoulder formed by the two annular structures 13 and 14 (FIG. 4).

As shown for example in FIGS. 1A, 2A, 3 and 4 of the accompanying drawings, the cylindrical sleeve 3 can be provided, on its external or internal surface, with a screw thread 3′, formed in a single piece by molding or obtained by machining.

Moreover, to ensure the mechanical connection of the connector 1 with a cord 11, the tubular body 2 is prolonged, on the side adapted to receive the connection wires connected to the connection terminals carried by said body 2, by a portion 2′ whose wall is provided with several perforations 2″ and is adapted to be at least partially overmolded during formation by overmolding of the connection body 10 between the cord 11 enclosing the connection wires and said tubular body 2.

The invention also has for its object a connection cord characterized in that it is provided at at least one of its ends with a connector 1 as described above.

Of course, the invention is not limited to the embodiments described and shown in the accompanying drawings. Modifications remain possible, particularly as to the construction of the various elements or by substitution of technical equivalents, without thereby departing from the scope of protection of the invention.

1. Electrical connector, male or female, comprising a tubular body of insulating material, carrying male or female connection terminals, and a cylindrical sleeve mounted for rotation on the external surface of said tubular body, characterized in that it comprises moreover a member (4) in the form of a ring, also mounted on the external surface of said tubular body (2) with the possibility of translation relative to this latter and being secured in rotation with this latter, said member (4) being provided with engagement means (5) and being adapted to be moved slidably into a locking position in which these engagement means (5) come into engagement with complementary engagement means (6) of the cylindrical sleeve (3), so as to render this latter also secured in rotation with said tubular body (2) by means of said member (4).

2. Connector according to claim 1, characterized in that the connection blocked in rotation and free in translation between the tubular body (2) and the sliding member (4) forming an intermediate ring for locking in rotation, is provided by at least one coacting assembly of lugs or ribs (7, 7′)/groove (8), in which the groove (8) extends in the axial direction of the connector (1) and forms a slideway for said lug or lugs or rib or ribs (7, 7′), said at least one lug or rib (7, 7′) being formed on the wall of one of said tubular body (2) and sliding member (4), and the groove (8) being provided in the wall of the other of said tubular body (2) or slidable member (4).

3. Connector according to claim 2, characterized in that it comprises at least two, preferably four coacting assemblies (7, 7′; 8) distributed equiangularly about the axis of said connector (1), in that each coacting assembly comprises at least two lugs (7 and 7′) aligned axially or a rib (7) with axial extent and in that said lugs (7 and 7′) or said rib (7) are formed on the external surface of the tubular body (2), the grooves (8) being formed on or in the internal surface of the sliding member (4) in the form of a ring.

4. Connector according to any one of claims 2 and 3, characterized in that the or each groove (8) comprises, at the level of its bottom, a protuberance (8′) forming an indexing lug whose passage over a lug (7) or into a cutout (7″) of the rib (7) of the coacting assembly (7, 7′; 8) in question, during sliding of the slidable member (4) in the form of a ring toward the locking position, corresponds to the establishment of the securement in rotation of the cylindrical sleeve (3) with the tubular body (2), said lug (7) or said cutout (7″) also ensuring the retention of said lug (8′) in the locking position.

5. Connector according to any one of claims 1 to 4, characterized in that the engagement means (5) of the sliding member (4) in the form of a ring consist of radial notches, preferably profiled in the axial direction of the connector (1), formed on the internal or external surface of said member (4) and in that the complementary engagement means (6) of the cylindrical sleeve (3) consist in a circular rib, also provided with or constituted by radial notches or made of a material less hard than that forming the engagement means (5) of the sliding member (4), said rib (6), notched or not, being formed on the external surface of the cylindrical sleeve (3) or on the internal surface of an annular portion (9) of greater diameter of said cylindrical sleeve (3).

6. Connector according to claim 5, characterized in that the radial notches (5) are present, continuously, over all the external or internal surface of the slidable member (4) in the shape of a ring and in that the circular rib (6) performing the complementary engagement means is also formed or provided with notches, the coacting assemblies (7, 7′)/(8) having a radial play permitting limited rotation of the tubular body (2) relative to the slidable member (4) in the form of a ring.

7. Connector according to any one of claims 1 to 6, characterized in that the member (4) in the form of a ring comprises a first tubular portion (4′) carrying on its external surface, the engagement means (5) and a second annular portion (4″) protruding radially toward the outside and forming a phalange, constituting an abutment shoulder against the cylindrical sleeve (3) in the locking position and a grip for driving in translation said member (4).

8. Connector according to any one of claims 2 to 6, characterized in that the member (4) in the form of a ring comprises, formed of one piece and concentric, a first annular structure (13) carrying on its internal surface the grooves (8) and a second annular structure (14) contiguous to the first (13), of greater diameter and carrying on its internal surface the engagement means (5), the tubular body (2) being provided with an external annular abutment (2′″) coming into contact, after assembly, with the edge of the annular structure (13) or with the shoulder formed by the two annular structures (13 and 14).

9. Connector according to any one of claims 1 to 8, characterized in that the cylindrical sleeve (3) is provided, on its external or internal surface, with a screw thread (3′), formed of a single piece by molding or obtained by machining.

10. Connector according to any one of claims 1 to 9, characterized in that the tubular body (2) is prolonged, on the side adapted to receive the connection wires connected to the connection terminals carried by said body (2), by a portion (2′) whose wall is provided with several perforations (2″) and adapted to be at least partially overmolded on the formation by overmolding of the connection body (10) between the cord (11) enclosing the connection wires and said tubular body (2).

11. Connecting cord, characterized in that it is provided at at least one of its ends with a connector (1) according to any one of claims 1 to 10.
